(19) United States
(12) Patent Application Publication
(10) Pub. No.: US 2019/0329180 A1
(43) Pub. Date: Oct. 31, 2019

(54) A PROCESS FOR LOW TEMPERATURE GAS CLEANING AND A CATALYST FOR USE IN THE PROCESS

(71) Applicant: Haldor Topsøe A/S, kgs. Lyngby (DK)

(72) Inventors: Janus Emil Münster-Swendsen, Espergærde (DK); Niklas Bengt Jakobsson, Kågeröd (SE)

(73) Assignee: Haldor Topsøe A/S, kgs. Lyngby (DK)

(21) Appl. No.: 16/310,096

(22) PCT Filed: Oct. 3, 2017
(86) PCT No.: PCT/EP2017/072746

§ 371 Date: Dec. 14, 2018

(30) Foreign Application Priority Data
Oct. 7, 2016 (DK) PA 2016 00602

(51) Int. Cl. B01D 53/86; B01J 23/42; B01D 53/76

(52) U.S. Cl. CPC B01D 53/86; B01J 21/063; B01D 53/76; B01J 23/42

(57) ABSTRACT

A process for the cleaning of a lean gas stream contaminated with volatile organic compounds and/or sulfur-containing compounds comprises the steps of adding ozone to the contaminated lean gas stream and contacting the resulting ozone-containing gas stream with a catalytic device at a temperature down to room temperature. Depending on the content of particulates in the lean gas stream, the catalytic device is either a monolithic catalyst or a catalytic bag filter, both impregnated with a catalyst containing one or more metal oxides, in which the metal is selected from vanadium, tungsten, palladium and platinum.

The present invention relates to a process for low temperature cleaning of lean gases and a catalyst for use in the process. More specifically, the process according to the invention consists in first adding ozone to a lean gas stream, which is contaminated by volatile organic compounds (VOCs) and/or sulfur-containing compounds such as H₂S or dimethyl sulfide, at a low temperature, i.e. a temperature down to room temperature, and then contacting the ozone-containing gas stream with a catalyst.

Previously, lean gas streams have just been emitted to the surroundings without any cleaning. However, with regulations becoming increasingly stringent, it is necessary to impose some action on such gas streams. Today, regenerative thermal oxidizers (RTOs) or scrubbers are typically used.

Catalytic processes are used for the removal of harmful components from waste gases. In this connection it is important to reduce the temperature of the catalytic reactions with a view to saving energy and at the same time keeping a high catalytic activity. Therefore, research and investigations are aimed at finding effective low temperature catalysts or new catalytic processes. An appropriate process in this respect is ozone catalytic oxidation (OZCO method), which uses ozone as an oxidant in catalytic oxidation reactions.

Ozone (trioxygen, O₃) is known as a strong oxidizing agent for waste and drinking water treatment, sterilization and deodoration. It is an allotrope of oxygen that is much less stable than the diatomic allotrope O₂, breaking down in the lower atmosphere to normal dioxygen. As mentioned, ozone is a powerful oxidant (far more so than dioxygen), and so it has many industrial applications related to oxidation. Because of the considerable oxidizing power of ozone and the formation of molecular oxygen as a by-product, ozone is sometimes chosen for oxidation. In fact, oxidation using ozone offers at least the following advantages over chemical alternatives:
ozone can be generated on-site,
ozone rapidly decomposes to oxygen, leaving no traces,
reactions do not produce toxic halogenated compounds, and
ozone acts more rapidly and more completely than other common oxidizing agents.

However, due to the fact that ozone itself is toxic, the residual ozone from these oxidation processes must be removed. Moreover, being quite harmful to animal and plant tissue even in concentrations as low as around 100 ppb, ozone is a pollutant that cannot be emitted. For these reasons, much research is devoted to find suitable catalysts for oxidation reactions using ozone and also to find effective ways of removing residual ozone following such oxidation reactions.

It has now surprisingly been found that a catalytic device, which contains a titanium dioxide carrier impregnated with vanadium and possibly also tungsten, palladium and/or platinum, can markedly reduce the content of volatile organic compounds (VOCs) and/or sulfur-containing compounds such as H₂S or dimethyl sulfide in a lean gas stream, to which ozone has been added, at low temperatures. Even more surprisingly it has further been found that this catalytic device not only reduces the VOCs and/or sulfur contents in the gas stream, but also removes residual ozone.

Journal of Colloid and Interface Science 446, 226-236 (2015) relates to investigations of the vapor phase catalytic oxidation of dimethyl sulfide (DMS) with ozone over nano-sized Fe₂O₃—ZrO₂ catalysts carried out at low temperatures, i.e. 50-200° C. The catalysts are different from those used in the process of the invention, and a possible removal of VOCs is not mentioned.

The catalytic oxidation of VOCs and CO by ozone over an alumina-supported cobalt oxide catalyst system with over-stoichiometric oxygen (CoOₓ/Al₂O₃) with heterogeneous catalytic decomposition of ozone is described in Applied Catalysis A: General 298, 109-114 (2008). Again the catalysts are different from those used in the process of the invention, and a possible removal of sulfur compounds is not mentioned.

US 2006/0084571 A1 discloses a low-temperature ozone catalyst which is a metal oxide. The specific purpose of the catalyst is to convert (i.e. destroy) ozone, particularly in airplane bleed air. This is done by an ozone destroying system consisting of a core and an active metal oxide wash-coat applied to the core, which destroys ozone. The metal oxide comprises an oxide of Cu, Fe, Co, Ni or combinations thereof.

In US 2011/0171094 A1, an apparatus and a method for the removal of particles and VOCs from an air stream is described. In this method, particles carried by the air stream are charged by a corona ionizer and then collected by an electrically enhanced filter downstream the ionizer. A catalytic filter downstream of the electrically enhanced filter removes the VOCs as well as ozone generated by the ionizer.

Finally, US 2014/0065047 A1 describes treatment of gases by catalytic ozone oxidation. The ozone oxidation catalyst has a porous body formed from a metal body, from a ceramic or from polymeric fibers coated with metal. A catalytic noble metal composition, the noble metal being palladium, platinum or both, is deposited on the surface of the porous body, and the catalytic noble metal composition is formed from particles of a noble metal supported by a mesoporous molecular sieve. The gas treatment consists in adding ozone, passing the gas over a filter comprising the ozone oxidation catalyst and removing the VOCs.

The present invention relates to a novel process for the cleaning of a lean gas stream contaminated with volatile organic compounds and/or sulfur-containing compounds, said process comprising
adding ozone to the contaminated lean gas stream, and
contacting the resulting ozone-containing gas stream with a catalytic device at a temperature down to room temperature,

wherein, depending on the content of particulates in the lean gas stream, the catalytic device is either a monolithic catalyst or a catalytic bag filter, both impregnated with a catalyst containing one or more metal oxides, in which the metal is selected from vanadium, tungsten, palladium and platinum.

A monolithic catalyst support consists of a substrate and a carrier and comprises many parallel channels separated by thin walls that are coated with the catalytic active substance. The substrate of a monolithic catalyst support is for instance a fiber structure, and the carrier can be titanium dioxide or another suitable compound. Because of a high open frontal area (the open spaces in the cross-sectional area), the pressure loss of gases flowing through the support is low, which is an important feature to minimize the efficiency loss.

In the present invention, the catalyst carrier is preferably titanium dioxide, and the preferred metal is vanadium added as vanadium oxide (V₂O₅).

If the feed gas has a high content of dust, a preferred solution is a catalytic bag filter containing the selected catalyst. Such a catalytic bag filter can be used, as it removes particles, destroys VOC and removes excess ozone in one step. Another option would be to utilize a non-catalytic bag filter or electrostatic precipitation (ESP), either before or after the monolithic catalyst, to remove particles.

In general, catalytic bag filters suffer from the inherent conflict of, on the one hand, catalysis being more efficient at high temperatures while, on the other hand, the bag filters being unable to tolerate higher temperatures. However, the present invention effectively overcomes this conflict, because the catalytic activity is high even at low temperatures.

The substrate for the catalytic filter bags is the woven fiber material. The carrier can be titanium dioxide or another suitable carrier. The catalytic material is impregnated onto the carrier and possibly also onto the substrate itself. The carrier (TiO₂) can itself be catalytically active in the process of the invention.

A catalyst consisting of vanadium and palladium supported on TiO₂ is capable of combusting particles, and so it can remove residual particulates, if present.

If no residual particles are present, and consequently no particulate removal is required, then only the catalyst and ozone will be needed in the process to convert VOCs.

In addition to removing VOCs and/or sulfur-containing compounds down to very low residual levels, the process of the invention has the important characteristic feature that the specific catalyst used in the process is able to remove any residual ozone. This is very important because, as already mentioned, ozone is very toxic, and therefore any residual ozone from the gas cleaning process has to be thoroughly removed.

In the process according to the invention, it is possible to heat the gas stream that is to be cleaned, but the most remarkable advantage of the process is that heating is not needed because it can work at any temperature down to room temperature (i.e. around 20° C.). Because of this fact, heat exchangers as well as a start-up heater and supplementary heaters are generally not needed, which leads to substantial investment capital savings. Moreover, the simplicity of the system makes the control of the process simple and easy.

Addition of ozone is widely used in wastewater treatment where it removes organic pollutants and microorganisms. This typically creates an emission of ozone, which is most often removed using a manganese catalyst.

However, in the case of the present invention, the ozone is applied to a gas stream, where the combination of the catalyst and the ozone means that the pollutants (VOCs and/or sulfur-containing compounds) can be removed even at low temperatures, thus saving cost on heat management equipment, such as heat exchangers, heaters etc.

With a process that works down to room temperature, the polluted gas stream can be treated directly without any heating. This is a great economic advantage, and the process is also made much simpler. It is important that all the ozone (O₃) is removed, which is secured by the catalyst used according to the process of the invention.

The invention is illustrated in more detail with reference to the appended Figures.

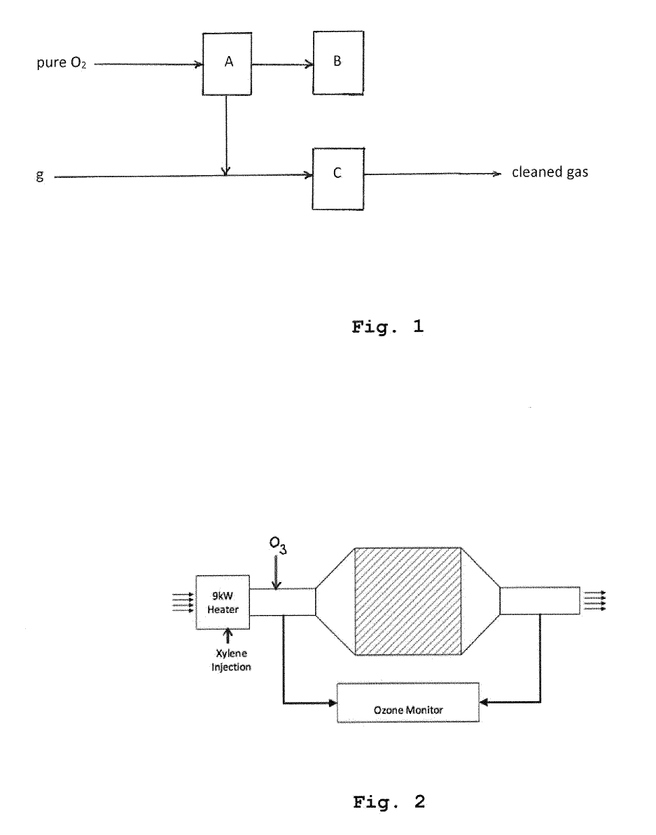

FIG. 1 shows the simple layout of the process according to the invention. Pure O₂ is fed to an ozone generator A, in which the O₂ stream is converted into a mixture of O₂ and O₃. For instance, in a 30 kW ozone generator, a 30 kg/h stream of pure O₂ is converted to 2.7 kg/h O₃ and 27.3 kg/h O₂. An 8 kW air-water cooling unit B is coupled to the ozone generator A. Instead of pure O₂, it is possible to use air as feed to the ozone generator.

To the gas stream g, which is to be cleaned, for instance 18000 kg/h, the mixture of 2.7 kg/h O₃ and 27.3 kg/h O₂ is added, and the resultant gas stream is passed over the ozone catalyst C. The result is 18030 kg/h of cleaned effluent gas.

FIG. 2 illustrates a working example of performance, as described in detail in the example which follows.

### EXAMPLE

The tested catalyst was a catalyst normally used for DeNOx and VOC removal purposes (TiO₂ carrier with V, W and Pd). The idea of the invention is to add ozone to this specific catalyst.

The feed to the 9 kW heater (see FIG. 2) is 600-1000 m³/hr air, and xylene is injected into the heater as an exemplary VOC (pollutant), the removal of which is measured. After the heater, ozone (O₃) is injected.

The table below shows the results, which were found:

| Flow | Xᵢₙ | Xₒᵤₜ | Tᵢₙ | XO₃ | | |
|---|---|---|---|---|---|---|
| m³/hr | ppm | ppm | ° C. | ppm | RE | O₃/VOC |
| 150 | 80 | 32 | 21.5 | 90 | 60% | 1.125 |
| 150 | 29.8 | 12.2 | 21.2 | 48 | 59% | 1.611 |
| 150 | 32 | 7 | 21.2 | 60 | 78% | 1.875 |
| 150 | 33 | 3 | 74 | 100 | 90% | 3.03 |

In the table, Xᵢₙ and Xₒᵤₜ are the concentrations in ppm of VOCs into and out of the catalyst, respectively. XO₃ is the concentration of ozone (O₃) into the catalyst, O₃/VOC is the ratio between ozone and VOC into the catalyst, calculated from the concentrations, and RE is the removal efficiency of VOC calculated from the calculations.

Efficient removal of the VOC was seen even at room temperature. Ozone was destroyed by the catalyst, resulting in a gas with a reduced VOC content and no ozone.

1. A process for the cleaning of a lean gas stream contaminated with volatile organic compounds and/or sulfur-containing compounds, said process comprising
adding ozone to the contaminated lean gas stream, and
contacting the resulting ozone-containing gas stream with a catalytic device at a temperature down to room temperature,
wherein, depending on the content of particulates in the lean gas stream, the catalytic device is either a monolithic catalyst or a catalytic bag filter, both impregnated with a catalyst containing one or more metal oxides, in which the metal is selected from vanadium, tungsten, palladium and platinum.

2. Process according to claim 1, wherein the catalytic device is a monolithic catalyst.

3. Process according to claim 1, wherein the catalytic device is a catalytic bag filter.

4. Process according to claim 1, wherein the catalyst carrier is titanium dioxide.

5. Process according to claim 1, wherein the metal of the catalyst is vanadium.

6. Process according to claim 1, wherein the temperature is between 20 and 200° C.

7. Process according to claim 6, wherein the temperature is lower than 50° C.

8. Process according to claim 1, wherein particulates are removed from the lean gas stream by passing the gas stream through a non-catalytic bag filter.

9. Process according to claim 1, wherein particulates are removed from the lean gas stream by electrostatic precipitation (ESP).

10. Process according to claim 3, wherein the catalytic bag filter comprises two or three layers of filter fabric, of which the outer layer captures particulates, while the inner layer is impregnated with the selected catalyst substance.

11. Process according to claim 10, wherein the inner layer of the catalytic bag filter contains a catalytic substance which is especially efficient in removing ozone, while the other layers contain catalytic substances which are more efficient for VOC removal.
